(19) United States
(12) Patent Application Publication
(10) Pub. No.: US 2021/0351411 A1
(43) Pub. Date: Nov. 11, 2021

(54) SECONDARY BATTERY AND METHOD OF PREPARING THE SAME

(71) Applicants: Samsung Electronics Co., Ltd., Suwon-si (KR); CORNING INCORPORATED, Corning, N (US)

(72) Inventors: Victor ROEV, Hwaseong-si (KR); Kyounghwan KIM, Seoul (KR); Sewon KIM, Suwon-si (KR); Jusik KIM, Hwaseong-si (KR); Michael Edward BADDING, Campbell, NY (US); Myungjin LEE, Seoul (KR); Jaemyung CHANG, Ansan-si (KR); Zhen SONG, Painted Post, NY (US)

(21) Appl. No.: 17/141,373

(22) Filed: Jan. 5, 2021

Related U.S. Application Data
(60) Provisional application No. 63/020,672, filed on May 6, 2020.

(30) Foreign Application Priority Data
Dec. 10, 2020 (KR) 10-2020-0172572

(51) Int. Cl. H01M 4/62; H01M 4/134; H01M 4/38; H01M 4/40; H01M 4/505; H01M 4/525; H01M 10/0562; H01M 10/052; H01M 4/131; H01M 10/0585

(52) U.S. Cl. CPC H01M 4/628; H01M 4/134; H01M 4/382; H01M 4/405; H01M 4/505; H01M 2300/0071; H01M 10/0562; H01M 10/052; H01M 4/131; H01M 10/0585; H01M 2300/0094; H01M 4/525

(57) ABSTRACT

A secondary battery includes a cathode layer including a cathode active material layer; an anode layer including an anode current collector and a metal layer disposed on the anode current collector; a solid electrolyte layer disposed between the cathode layer and the anode layer; and a graphite interlayer disposed between the solid electrolyte layer and the anode layer, wherein the interlayer comprises a graphite material having a crystallite size of about 1000 angstroms to about 1500 angstroms, when measured from a (110) diffraction peak, and having a hexagonal interplanar spacing about 500 angstroms to about 800 angstroms in a c-axis direction, when measured from a (002) diffraction peak, an aspect ratio of the graphite material is in a range of between about 0.44 and about 0.55.

### CROSS-REFERENCE TO RELATED APPLICATION

This application claims priority to and the benefit of U.S. Provisional Patent Application No. 63/020,672, filed on May 6, 2020, in the United States Patent and Trademark Office, and Korean Patent Application No. 10-2020-0172572, filed on Dec. 10, 2020, in the Korean Intellectual Property Office, the content of which is incorporated herein in its entirety by reference.

### BACKGROUND

### 1. Field

The present disclosure relates to a secondary battery and a method of preparing the secondary battery.

### 2. Description of Related Art

Recently, an all-solid secondary battery using a solid electrolyte as an electrolyte has attracted attention. It has been suggested to use lithium as an anode active material to increase an energy density of the all-solid secondary battery. For example, a specific capacity (capacity per unit weight) of lithium is known to be about 10 times the specific capacity of graphite, which is generally used as an anode active material. Therefore, when lithium is used as an anode active material, the all-solid secondary battery may be prepared as a thin film, and an output of the battery may increase. Nonetheless, there remains a need for improved battery materials.

### SUMMARY

Provided is a secondary battery exhibiting excellent performance, which may prevent a short-circuit that may occur due to lithium (lithium metal) precipitated in an anode layer during a charge process of an all-solid secondary battery.

Provided is a secondary battery having excellent charge/discharge characteristics.

Provided is a secondary battery that is easier to manufacture and has reduced manufacturing costs compared to commercially available secondary batteries.

Additional aspects will be set forth in part in the description which follows and, in part, will be apparent from the description.

According to an aspect, a secondary battery includes a cathode layer including a cathode active material layer; an anode layer including an anode current collector and a metal layer disposed on the anode current collector; a solid electrolyte layer disposed between the cathode layer and the anode layer; and a graphite interlayer disposed between the solid electrolyte layer and the anode layer, wherein the graphite interlayer includes a graphite material having a crystallite size of about 1000 angstroms to about 1500 angstroms measured from a (110) diffraction peak, when analyzed by X-ray diffraction, and having a hexagonal interplanar spacing about 500 angstroms to about 800 angstroms in a c-axis direction measured from a (002) diffraction peak, when analyzed by X-ray diffraction, an aspect ratio of the graphite material is in a range of about 0.44 to about 0.55.

The metal layer may include at least one of lithium or a lithium alloy.

The lithium alloy may include at least one of a Li—Al alloy, a Li—Sn alloy, a Li—In alloy, a Li—Ag alloy, a Li—Au alloy, a Li—Zn alloy, a Li—Ge alloy, or a Li—Si alloy.

The cathode active material layer may include at least one of a lithium cobalt oxide (LCO), a lithium nickel oxide, a lithium nickel cobalt oxide, a lithium nickel cobalt aluminum oxide (NCA), a lithium nickel cobalt manganese oxide (NCM), a lithium manganate, or a lithium iron phosphate. The solid electrolyte layer may include at least one of Li₃₊ₓLa₃M₂O₁₂, wherein 0≤x≤10, Li₃PO₄, LiₓTi_{y}(PO₄)₃, wherein 0<x<2 and 0<y<3, LiₓAl_{y}Ti_{z}(PO₄)₃, wherein 0<x<2, 0<y<1, and 0<z<3, Li_{1+x+y}(AlₐGa₁₋ₐ)ₓ(Ti_{b}Ge_{1-b})₂₋ₓSi_{y}P_{3-y}O₁₂, wherein 0≤x≤1, 0≤y≤1, 0≤a≤1, 0≤b≤1, LiₓLa_{y}TiO₃, wherein 0<x<2 and 0<y<3, a LiₓM_{y}P_{z}S_{w}, wherein M is at least one of Ge, Si, or Sn, and 0<x<4, 0<y<1, 0<z<1, and 0<w<5, LiₓN_{y}, wherein 0<x<4 and 0<y<2, LiₓPO_{y}N_{z}, wherein 0<x<4, 0<y<5, and 0<z<4, a LiₓSi_{y}S_{z}, wherein 0<x<3, 0<y<2, and 0<z<4, a LiₓP_{y}S_{z}, wherein 0<x<3, 0<y<3, and 0<z<7, Li₂O, LiF, LiOH, Li₂CO₃, LiAlO₂, a Li₂O—Al₂O₃—SiO₂—P₂O₅—TiO₂—GeO₂, or a LiₓLa_{y}M_{z}O₁₂, wherein M is at least one of Te, Nb, or Zr, and 1<x<5, 0<y<4, and 0<z<4.

A thickness of the solid electrolyte layer may be in a range of about 10 μm to about 250 μm.

The graphite interlayer may include a binder.

The binder may include at least one of polyvinylidene fluoride (PVDF), polyvinyl alcohol (PVA), or a polyvinyl alcohol-polyacrylic acid (PVA-PAA) copolymer, carboxymethyl cellulose (CMC), styrene-butadiene rubber (SBR) and an amount of the binder may be in a range of about 1 weight percent (wt %) to about 10 wt %, based on the total weight of the graphite interlayer.

The graphite interlayer may further include at least one of iron (Fe), zirconium (Zr), gold (Au), platinum (Pt), palladium (Pd), silicon (Si), silver (Ag), aluminum (Al), bismuth (Bi), tin (Sn), or zinc (Zn).

The secondary battery may be a lithium battery.

The cathode layer may further include a cathode current collector disposed on a surface of the cathode active material layer.

According to another aspect, a method of preparing the secondary battery may include providing a solid electrolyte layer; mechanically milling a surface of the solid electrolyte layer to provide a milled surface; contacting the solid electrolyte layer with an oxidizing gas to provide an oxidized solid electrolyte layer; drying the solid electrolyte layer in air to provide a dried solid electrolyte layer; coating a graphite interlayer on the milled surface to provide a coated solid electrolyte layer; disposing a stack including a metal layer and an anode current collector on the coated solid electrolyte layer to provide an anode layer; and disposing a cathode layer including a cathode active material layer on a surface of the solid electrolyte layer opposite to the anode layer, wherein the graphite interlayer includes a graphite material having a crystallite size of about 1000 angstroms to about 1500 angstroms measured from a (110) diffraction peak, when analyzed using X-ray diffraction, and having a hexagonal interplanar spacing about 500 angstroms to about 800 angstroms in a c-axis direction measured from a (002) diffraction peak, when analyzed by X-ray diffraction, an aspect ratio of the graphite material in the graphite interlayer is in a range of about 0.44 to about 0.55.

The coating of the graphite interlayer may be provided by ink-coating or pencil-drawing.

The disposing of the stack including a metal layer and an anode current collector further comprises cold isostatic pressing to dispose the stack comprising a metal layer and an anode current collector on the graphite interlayer.

The cathode active material layer may include at least one of a lithium cobalt oxide (LCO), a lithium nickel oxide, a lithium nickel cobalt oxide, a lithium nickel cobalt aluminum oxide (NCA), a lithium nickel cobalt manganese oxide (NCM), a lithium manganate, or a lithium iron phosphate.

The solid electrolyte layer may include a solid electrolyte material that is at least one of Li₃₊ₓLa₃M₂O₁₂, wherein 0≤x≤10, Li₃PO₄, LiₓTi_{y}(PO₄)₃, wherein 0<x<2 and 0<y<3, LiₓAl_{y}Ti_{z}(PO₄)₃, wherein 0<x<2, 0<y<1, and 0<z<3, Li_{1+x+y}(AlₐGa₁₋ₐ)ₓ(Ti_{b}Ge_{1-b})₂₋ₓSi_{y}P_{3-y}O₁₂, wherein 0≤x≤1, 0≤y≤1, 0≤a≤1, and 0≤b≤1, LiₓLa_{y}TiO₃, wherein 0<x<2 and 0<y<3, a LiₓM_{y}P_{z}S_{w}, wherein M is at least one of Ge, Si, or Sn, and 0<x<4, 0<y<1, 0<z<1, and 0<w<5, LiₓN_{y}, wherein 0<x<4 and 0<y<2, LiₓPO_{y}N_{z}, wherein 0<x<4, 0<y<5, and 0<z<4, a LiₓSi_{y}S_{z}, wherein 0<x<3, 0<y<2, and 0<z<4, a LiₓP_{y}S_{z}, wherein 0<x<3, 0<y<3, and 0<z<7, Li₂O, LiF, LiOH, Li₂CO₃, LiAlO₂, a Li₂O—Al₂O₃—SiO₂—P₂O₅—TiO₂—GeO₂, and LiₓLa_{y}M_{z}O₁₂, wherein M is at least one of Te, Nb, or Zr, and 1<x<5, 0<y<4, and 0<z<4.

The metal layer may include at least one of lithium or a lithium alloy.

The cathode layer may further include a cathode current collector disposed on a surface of the cathode active material layer.

The graphite interlayer may further include at least one of iron (Fe), zirconium (Zr), gold (Au), platinum (Pt), palladium (Pd), silicon (Si), silver (Ag), aluminum (AI), bismuth (Bi), tin (Sn), or zinc (Zn).

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a cross-sectional schematic view that shows a structure of a secondary battery according to an embodiment;

FIG. 2 is a scanning electron microscope (SEM) image of a cross-section of a secondary battery after over-charging a secondary battery according to an embodiment;

FIG. 3A is a cross-sectional schematic view that shows a structure of a commercially available secondary battery before charging the battery;

FIG. 3B is a cross-sectional schematic view that shows a commercially available secondary battery after over-charging the commercially available secondary battery;

FIG. 3C is an SEM image of a cross-section of a commercially available secondary battery after over-charging the commercially available secondary battery;

FIG. 4 is a graph of counts (arbitrary units) versus diffraction angle (° 2Θ) of a graphite-based material included in a graphite-based interlayer, analyzed by X-ray diffraction using Cu Kα radiation;

FIG. 5A is an SEM image of the graphite-based interlayer, according to an embodiment;

FIG. 5B is a graph showing an elemental analysis of the first selected area in FIG. 5A, when analyzed by X-ray diffraction;

FIG. 5C is a graph showing an elemental analysis of the second selected area in FIG. 5A, when analyzed by X-ray diffraction;

FIG. 5D is a graph showing an elemental analysis of the third selected area in FIG. 5A, when analyzed by X-ray diffraction;

FIGS. 6A to 6G are schematic views that illustrate a secondary battery according to an embodiment during various steps of preparing the secondary battery;

FIG. 7 is a graph of energy efficiency (%) versus number of charge/discharge cycles (#) that shows output characteristics of a secondary battery according to an embodiment and a secondary battery prepared in Comparative Example 1; and

FIG. 8 is a graph of voltage (V) versus areal capacity (milliampere hours per square centimeter, mAh/cm²) that shows charge/discharge characteristics of a secondary battery according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

Hereinafter, as the present inventive concept allows for various changes and numerous embodiments, particular embodiments will be illustrated in the drawings and described in detail in the written description. However, this is not intended to limit the present inventive concept to particular modes of practice, and it is to be appreciated that all changes, equivalents, and substitutes that do not depart from the spirit and technical scope are encompassed in the present inventive concept.

The terms used herein are merely used to describe particular embodiments, and are not intended to limit the present inventive concept. An expression used in the singular encompasses the expression of the plural, unless it has a clearly different meaning in the context. As used herein, it is to be understood that the terms such as “including,” “having,” and “comprising” are intended to indicate the existence of the features, numbers, steps, actions, components, parts, ingredients, materials, or combinations thereof disclosed in the specification, and are not intended to preclude the possibility that one or more other features, numbers, steps, actions, components, parts, ingredients, materials, or combinations thereof may exist or may be added. The symbol “/” used herein may be interpreted as “and” or “or” according to the context.

Throughout the specification, it will be understood that when a component, such as a layer, a film, a region, or a plate, is referred to as being “on” another component, the component may be directly on the other component or intervening components may be present thereon. In contrast, when an element is referred to as being “directly on” another element, there are no intervening elements present. Throughout the specification, while such terms as “first,” “second,” etc., may be used to describe various components, regions, layers, or sections, such terms are not limited to the above terms. The above terms are used only to distinguish one component, region, layer, or section from another. Thus, “a first element,” “component,” “region,” “layer,” or “section” discussed below could be termed a second element, component, region, layer or section without departing from the teachings herein.

The terminology used herein is for the purpose of describing particular embodiments only and is not intended to be limiting. For example, “an element” has the same meaning as “at least one element,” unless the context clearly indicates otherwise. “At least one” is not to be construed as limiting “a” or “an.” “Or” means “and/or.” It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Examples of a method of using lithium as an anode active material may include a method of using lithium or a lithium alloy as an anode active material layer and a method where an anode active material layer does not form on an anode current collector. In the method where an anode active material layer is not formed on an anode current collector, a solid electrolyte layer is formed on the anode current collector, and lithium is precipitated at an interface between the anode current collector and the solid electrolyte by charging of the battery and may be used as an active material. The anode current collector is formed of a metal that does not form an alloy or a compound with lithium. However, in these methods where lithium is used as an active material, lithium tends to form columns that result in areas within the anode layer that have low density, which leads to areas of high local density that can lead to a low energy efficiency and/or a short circuit in an all-solid secondary battery and thus an improved anode layer in an all-solid secondary battery is needed.

Hereinafter, according to one or more embodiments, a secondary battery and a method of preparing the same will be described in detail with reference to the accompanying drawings. In the drawings, the widths and thicknesses of layers and regions are exaggerated for clarity of the specification and convenience of the explanation. Like reference numerals in the drawings denote like elements.

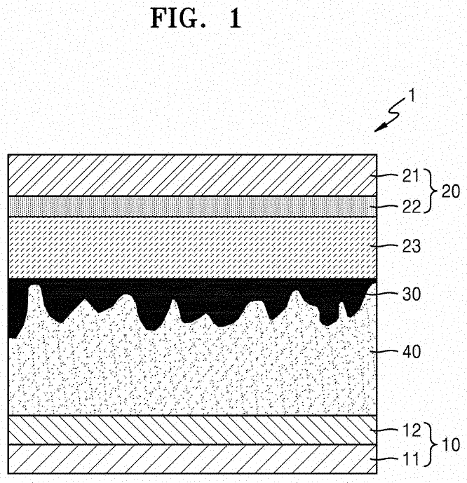

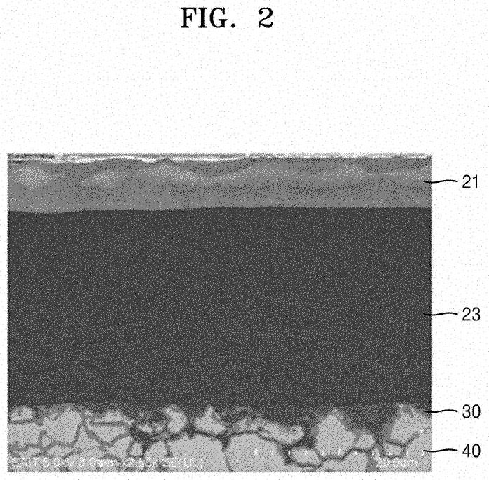

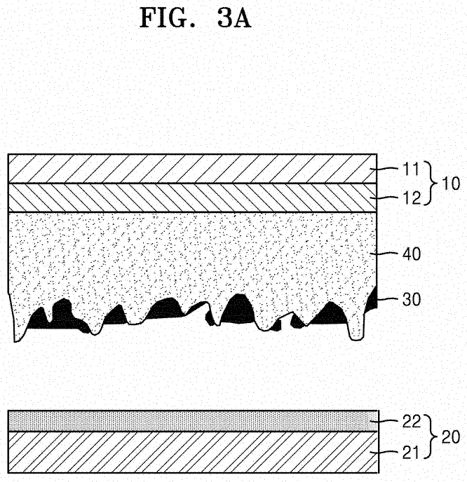

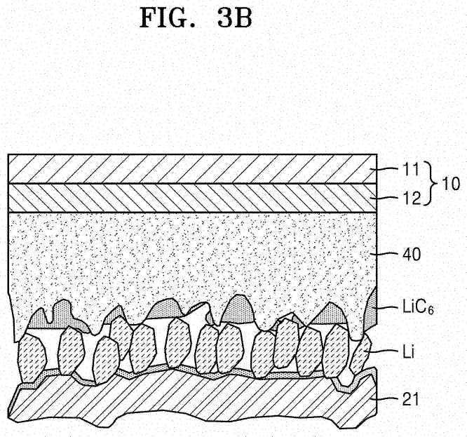

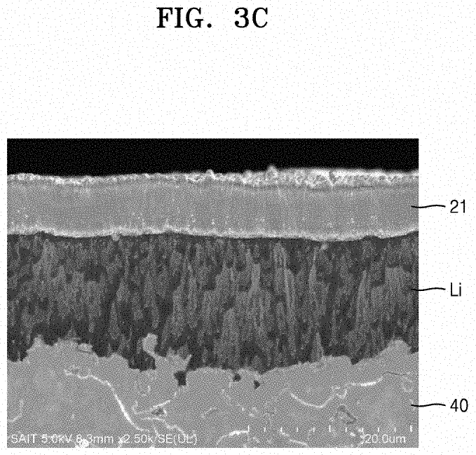

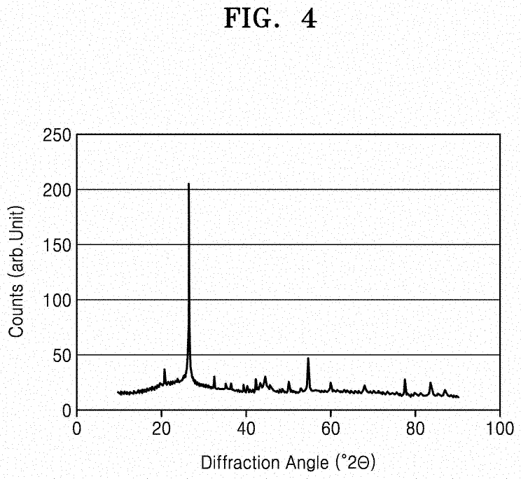

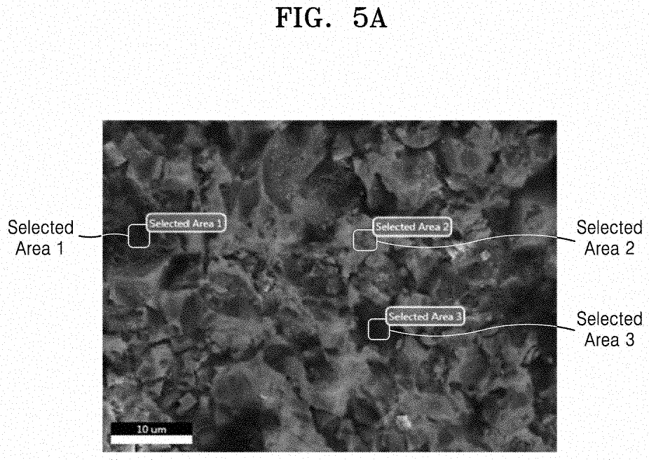

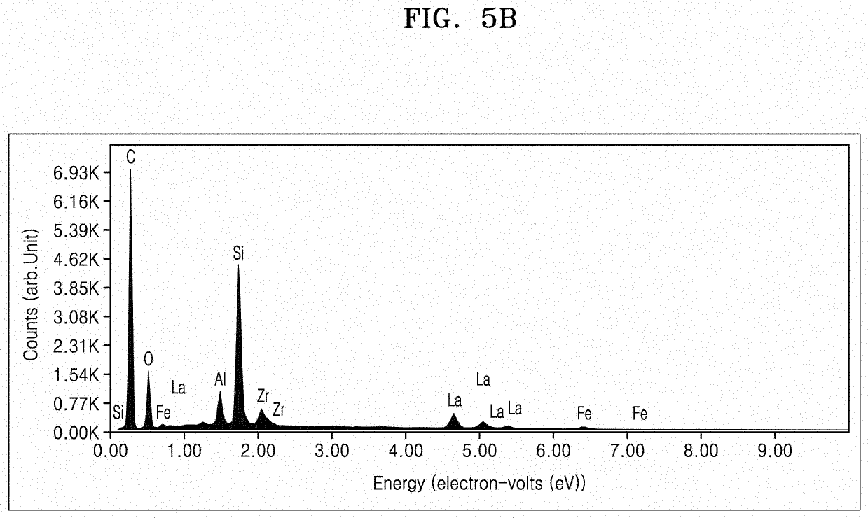

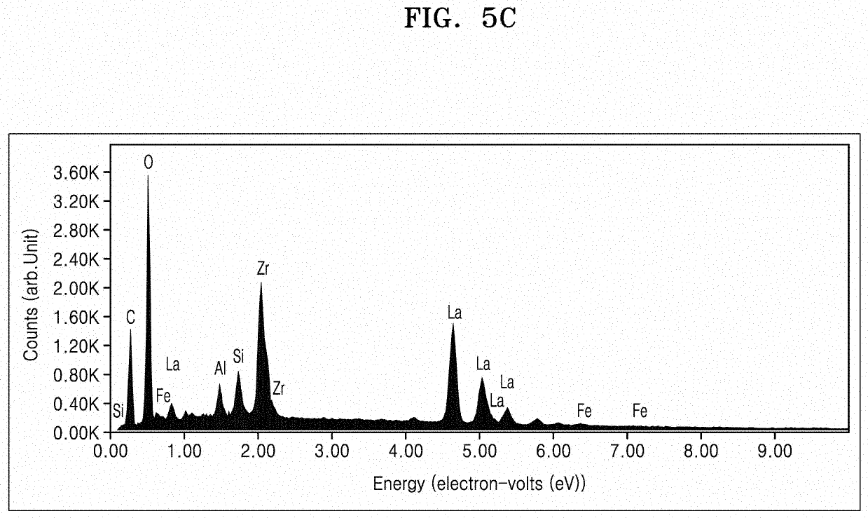

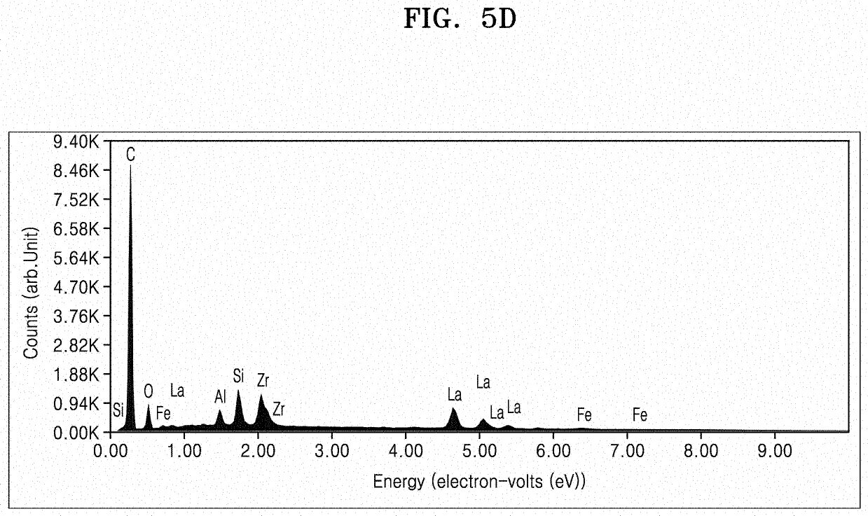

FIG. 1 is a cross-sectional schematic view that shows a structure of a secondary battery according to an embodiment. FIG. 2 is a scanning electron microscope (SEM) image of a cross-section of a secondary battery after over-charging the secondary battery according to an embodiment. FIG. 3A is a cross-sectional schematic view that shows a structure of a commercially available secondary battery before charging the commercially available secondary battery. FIG. 3B is a cross-sectional schematic view of a commercially available secondary battery after over-charging the commercially available secondary battery. FIG. 3C is an SEM image of a cross-section of a commercially available secondary battery after over-charging the commercially available secondary battery. FIG. 4 is a graph of a graphite-based material included in a graphite-based interlayer, analyzed by X-ray diffraction using Cu Kα radiation, according to an embodiment. FIG. 5A is an SEM image of the graphite-based interlayer, according to an embodiment. FIG. 5B is a graph showing an elemental analysis of a first selected area analyzed by X-ray diffraction using Cu Kα radiation in FIG. 5A. FIG. 5C is a graph showing an elemental analysis of a second selected area in FIG. 5A, when analyzed by an X-ray diffraction using Cu Kα radiation. FIG. 5D is a graph showing an elemental analysis of a third selected area in FIG. 5A, when analyzed by an X-ray diffraction using Cu Kα radiation.

Referring to FIGS. 1 and 2, a secondary battery 1 according to an embodiment may include a cathode layer 10; an anode layer 20; a graphite interlayer 30; and a solid electrolyte layer 40. In an embodiment, the cathode layer 10 may include a cathode current collector 11 and a cathode active material layer 12. For example, the cathode current collector 11 may include at least one of indium (In), copper (Cu), magnesium (Mg), stainless steel, titanium (Ti), iron (Fe), cobalt (Co), nickel (Ni), zinc (Zn), aluminum (AI), germanium (Ge), lithium (Li), or an alloy thereof. For example, the cathode current collector 11 may be a plate-like type or a thin-film type. In an embodiment, the cathode current collector 11 may be omitted.

The cathode active material layer 12 may include a cathode active material and a solid electrolyte. Also, the solid electrolyte in the cathode layer 10 may be similar to or different from a solid electrolyte in the solid electrolyte layer 40. The solid electrolyte in the cathode layer 10 is the same as defined in relation to the solid electrolyte layer 40.

In an embodiment, the cathode active material is capable of reversibly intercalating and deintercalating lithium ions. For example, the cathode active material may include at least one of a lithium cobalt oxide (hereinafter also referred to as “LCO”), a lithium nickel oxide, a lithium nickel cobalt, oxide, a lithium nickel cobalt aluminum oxide (hereinafter also referred to as “NCA”), a lithium nickel cobalt manganese oxide (hereinafter also referred to as “NCM”), a lithium manganate, a lithium iron phosphate, a nickel sulfide, a copper sulfide, a lithium sulfide, sulfur, an iron oxide, or a vanadium oxide. For example, the cathode active material may include only one of the foregoing materials or may be a compound in which at least two of the foregoing materials are combined. In an aspect, the use of a combination of a cathode active materials is mentioned.

For example, when the cathode active material is formed of a lithium salt of a ternary transition metal oxide such as NCA or NCM, and the cathode active material includes nickel (Ni), the capacity density of the secondary battery 1 may be increased, and thus elution of metal from the cathode active material in a charged state of the secondary battery 1 may be reduced. Examples of the ternary transition metal oxide may include ternary transition metal oxides represented by the formula LiNiₓCo_{y}Al_{z}O₂ (NCA) or LiNiₓCo_{y}Mn_{z}O₂ (NCM) (where 0<x<1, 0<y<1, 0<z<1, and x+y+z=1). Accordingly, the secondary battery 1 may have improved long-term reliability and improved cycle characteristics.

In an embodiment the cathode active material may be, for example, in the form of a particle and have a shape such as a spherical shape or an elliptical shape. In addition, a diameter of a particle of the cathode active material is not particularly limited. Also, an amount of the cathode active material in the cathode layer 10 is not particularly limited.

In an embodiment, the anode layer 20 may include an anode current collector 21 and a metal layer 22. In an embodiment, the anode current collector 21 may include a material that does not react, i.e., does not form an alloy or a compound, with lithium. For example, the anode current collector 21 may include at least one of copper (Cu), stainless steel, titanium (Ti), iron (Fe), cobalt (Co), or nickel (Ni). In an embodiment, the anode current collector 21 may include one of the foregoing elements or an alloy including at least two of the foregoing elements. In an embodiment, the anode current collector 21 may be a plate-like type or a thin-film type.

In an embodiment, the metal layer 22 may include lithium or a lithium alloy. That is, the metal layer 22 may function as a lithium reservoir. Examples of the lithium alloy may include at least one of a Li—Al alloy, a Li—Sn alloy, a Li—In alloy, a Li—Ag alloy, a Li—Au alloy, a Li—Zn alloy, a Li—Ge alloy, a Li—Si alloy, or a Li—C alloy. For example, the metal layer 22 may include lithium or one or more of these lithium alloys.

Also, a thickness of the metal layer 22 may be, for example, in a range of about 1 μm to about 200 μm, for example, about 5 μm to about 190 μm, about 10 μm to about 180 μm, about 20 μm to about 170 μm, about 40 μm to about 160 μm, about 80 μm to about 150 μm, or about 100 μm to about 140 μm. When a thickness of the metal layer 22 is less than 1 μm, the metal layer 22 may not sufficiently function as a lithium reservoir. When a thickness of the metal layer 22 is greater than 200 μm, a weight and a volume of the secondary battery 1 increase and thus, capacity characteristics of the secondary battery 1 may be deteriorated. In an embodiment, the metal layer 22 may be, for example, a metal foil having a thickness within a range of about 1 μm to about 200 μm.

In an embodiment, the graphite interlayer 30 may include a graphite material that forms an alloy or a compound with lithium. In an embodiment, lithium is intercalated into the graphite interlayer 30 during initial charge of the secondary battery 1. That is, the graphite material may form an alloy or a compound with lithium ions migrated from the cathode layer 10. When the secondary battery 1 is charged over a capacity of the graphite interlayer 30, lithium is precipitated on a back surface of the graphite interlayer 30, e.g., between the metal layer 22 and the graphite interlayer 30, and a metal layer 23 is formed by the precipitated lithium. The metal layer 23 may include lithium (e.g., lithium metal or a lithium metal alloy).

Also, according to an embodiment, during discharge of the secondary battery 1, lithium of the graphite interlayer 30 and the metal layer 23 is ionized and the lithium ions move toward the cathode layer 10. Therefore, lithium in the secondary battery 1 may be used as an anode active material. Also, when the graphite interlayer 30 covers the metal layer 23, the graphite interlayer 30 may serve as a protection layer of the metal layer 23 and may prevent lithium from growing as a dendrite structure during precipitation, at the same time. When crystallization of the graphite interlayer 30 is not sufficient, the graphite interlayer may not sufficiently function as a protection layer.

As shown in FIG. 3A, which shows a commercially available secondary battery, when a graphite interlayer 30 is disposed on one surface of a solid electrolyte layer 40 having a shape other than a plane shape, the graphite interlayer 30 and a metal layer 22 may be changed to a metal oxide (LiC₆) as shown in FIGS. 3B and 3C. In the commercially available secondary battery, lithium produced during a charge process of the commercially available secondary battery may be precipitated in a dendrite structure, which may cause a short-circuit and a decrease in capacity of the commercially available secondary battery.

In an embodiment, the graphite interlayer 30 may include a graphite material having a predetermined crystallinity. For example, as shown in FIG. 4, the graphite material in the graphite interlayer 30 may have a crystallite size (La) of the graphite material measured from a (110) diffraction peak by using X-ray diffraction is about 1000 Å or more, for example from about 1000 Å to about 1500 Å, a hexagonal interplanar spacing (Lc) in a c-axis direction measured from a (002) diffraction peak by using X-ray diffraction is about 500 Å or more, for example from about 500 Å to about 800 Å, and an aspect ratio in a range of about 0.44 to about 0.55.

In an embodiment, a size of a particle of the graphite material measured by using X-ray diffraction may be defined as a crystallite size. A method of measuring the crystallite size uses a peak broadening of the (110) diffraction of the X-ray diffraction data shown in FIG. 4, and thus the method allows estimation of the crystallite size and quantitative calculation of the crystallite size using the Scherrer equation. In an embodiment when a crystallite size (La) of the graphite material is 1000 Å or greater, the crystallites may have a size sufficient for crystallization.

Also, the hexagonal interplanar spacing (Lc) is an index indicating a graphitizing degree of the graphite material particles. In an embodiment, the hexagonal interplanar spacing (Lc) may be calculated using the Bragg's equation by using a peak position of a graph of the (002) diffraction of X-ray diffraction data obtained by integration. In an embodiment, the less the hexagonal interplanar spacing (Lc), the more crystals of the graphite material particles may develop. That is, the graphitizing degree may increase. In an embodiment, the hexagonal interplanar spacing (Lc) of the graphite material may be 500 Å or greater.

As described above, when the crystallite size (La) of the graphite material in the graphite interlayer 30 is 1000 Å or greater, and the hexagonal interplanar spacing (Lc) in a c-axis direction measured from a (002) diffraction peak by using X-ray diffraction is 500 Å or greater, the graphite interlayer 30 is disposed on a surface of the solid electrolyte layer 40 in a plane shape, as shown in FIG. 1. On the other hand, when the crystallite size (La) of the graphite material in the graphite interlayer 30 is less than 1000 Å, and the hexagonal interplanar spacing (Lc) in a c-axis direction measured from a (002) diffraction peak by using X-ray diffraction is less than 500 Å, the graphite interlayer 30 is not disposed on a surface of the solid electrolyte layer 40 in a plane shape, as shown in FIG. 3A.

According to an embodiment, an average aspect ratio of the graphite material may be in a range of about 0.44 to about 0.55. As used herein, the average aspect ratio of the graphite material denotes a ratio (Lc/La) of a hexagonal interplanar spacing (Lc) in a c-axis direction measured from a (002) diffraction peak by using X-ray diffraction with respect to a crystallite size (La) of the graphite material in the graphite interlayer 30. In an embodiment, when the average aspect ratio of the graphite material is within this range, the graphite-based interlayer 30 may be expanded in a uniform direction.

In an embodiment, the graphite interlayer 30 may further include materials in addition to a graphite material having a crystallinity. In an embodiment, the graphite interlayer 30 may include a mixture of the graphite material and at least one of iron (Fe), zirconium (Zr), gold (Au), platinum (Pt), palladium (Pd), silicon (Si), silver (Ag), aluminum (AI), bismuth (Bi), tin (Sn), or zinc (Zn). However, embodiments are not limited thereto, and the graphite material may include at least one of aluminum (AI), silicon (Si), titanium (Ti), zirconium (Zr), niobium (Nb), germanium (Ge), gallium (Ga), silver (Ag), indium (In), tin (Sn), antimony (Sb), or bismuth (Bi). When the graphite interlayer 30 includes the mixture, characteristics of the secondary battery 1 may improve.

In an embodiment, the graphite interlayer 30 may include a binder. For example, the binder may include at least one of polyvinylidene fluoride (PVDF), polyvinyl alcohol (PVA), or a polyvinyl alcohol-polyacrylic acid (PVA-PAA) copolymer carboxymethyl cellulose (CMC), styrene-butadiene rubber (SBR). In an embodiment, when the graphite interlayer 30 includes a binder, the graphite interlayer 30 may be stably disposed on the solid electrolyte layer 40. For example, when the graphite interlayer 30 does not include a binder, the graphite interlayer 30 may be easily detached from the solid electrolyte layer 40. If a part of the graphite-based interlayer 30 is detached from the solid electrolyte layer 40, the solid electrolyte layer 40 may be exposed to the metal layer 23, and thus a short-circuit may occur. In an embodiment, when the graphite interlayer 30 includes a binder, an amount of the binder may be in a range of about 1 weight % (wt %) to about 10 wt %, based on the total weight of the graphite interlayer 30. When the amount of the binder is lower than about 1 wt %, strength of the layer is not sufficient, the characteristics of the layer may be deteriorated, and the layer may become difficult to handle. When the amount of the binder is higher than about 5 wt %, characteristics of the secondary battery 1 may be deteriorated.

A thickness of the graphite interlayer 30 may be, for example, in a range of about 0.1 μm to about 0.3 μm. When the thickness of the graphite interlayer 30 is less than about 0.1 μm, characteristics of the secondary battery 1 may not improve. When the thickness of the graphite interlayer 30 is greater than about 0.3 μm, a resistance of the graphite interlayer 30 is high, which may deteriorate characteristics of the secondary battery 1. When the binder described herein is used, a thickness of the graphite interlayer 30 may be appropriate to improve the characteristics of a secondary battery.

In an embodiment, the solid electrolyte layer 40 may be disposed between the cathode layer 10 and the anode layer 20. In an embodiment, the solid electrolyte layer 40 may include a solid electrolyte material such as Li₃₊ₓLa₃M₂O₁₂ (where 0≤x≤10), Li₃PO₄, LiₓTi_{y}(PO₄)₃ (where 0<x<2 and 0<y<3), LiₓAl_{y}Ti_{z}(PO₄)₃ (where 0<x<2, 0<y<1, and 0<z<3), Li_{1+x+y}(AlₐGa₁₋ₐ)ₓ(Ti_{b}Ge_{1-b})₂₋ₓSi_{y}P_{3-y}O₁₂ (where 0≤x≤1, 0≤y≤1, 0≤a≤1, and 0≤b≤1), LiₓLa_{y}TiO₃ (where 0<x<2 and 0<y<3), LiₓM_{y}P_{z}S_{w}— (M is Ge, Si, or Sn, where 0<x<4, 0<y<1, 0<z<1, and 0<w<5), LiₓN_{y} (where 0<x<4 and 0<y<2), LiₓPO_{y}N_{z} (where 0<x<4, 0<y<5, and 0<z<4), SiS₂ (LiₓSi_{y}S_{z}, where 0<x<3, 0<y<2, and 0<z<4), P₂S₅ (LiₓP_{y}S_{z}, where 0<x<3, 0<y<3, and 0<z<7), Li₂O, LiF, LiOH, Li₂CO₃, LiAlO₂, Li₂O—Al₂O₃—SiO₂—P₂O₅—TiO₂—GeO₂, LiₓLa_{y}M_{z}O₁₂ (M is at least one of Te, Nb, or Zr, where 1<x<5, 0<y<4, and 0<z<4), or LiₓLa_{y}Zr_{z1}M_{z2}O₁₂ (M is at least one of B, Si, Al, Ga, Ge, Te, Nb, Hf, Ta, Ru, W, or Re, where 1<x<5, 0<y<4, 0<z1<4, or 0<z2<4).

As described herein, the solid electrolyte layer 40 may include an ion conductive material to allow ion conduction between the cathode layer 10 and the anode layer 20 or may include an ion conductive material and an ion non-conductive material. Also, the solid electrolyte layer 40 may be used as a separation layer that physically or chemically separates the cathode layer 10 and the anode layer 20. In an embodiment, a thickness of the solid electrolyte layer 40 may be in a range of about 10 μm to about 250 μm, for example, from about 20 μm to about 225 μm, from about 40 μm to about 200 μm, from about 60 μm to about 175 μm, from about 80 μm to about 150 μm, or from about 100 μm to about 125 μm. However, embodiments are not limited thereto.

The solid electrolyte layer 40 may further include a binder. Examples of the binder in the solid electrolyte layer 40 may include at least one of styrene butadiene rubber (SBR), polytetrafluoroethylene, polyvinylidene fluoride, or polyethylene. However, embodiments are not limited thereto, and the binder of the solid electrolyte layer 40 may be identical to or different from a binder of the cathode active material layer 12 or the graphite-based interlayer 30.

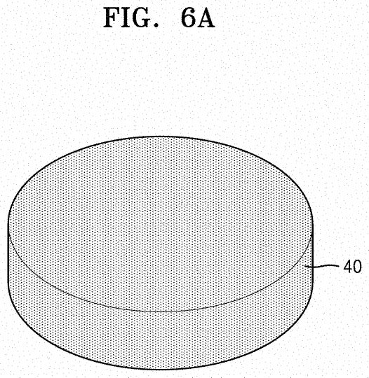

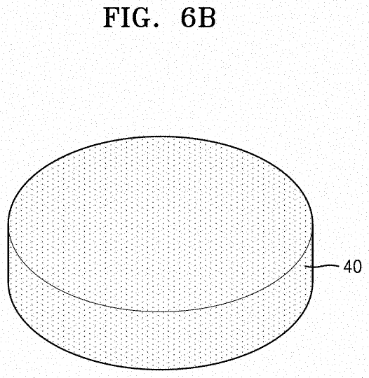

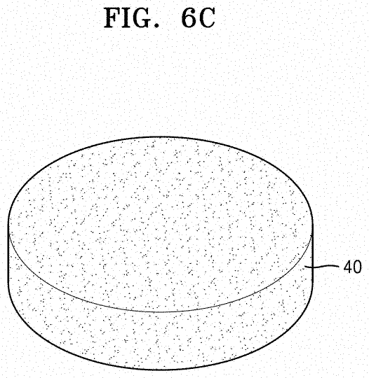

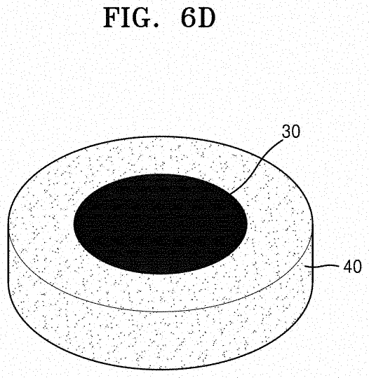

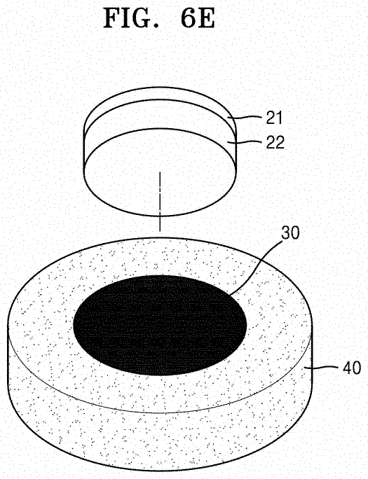

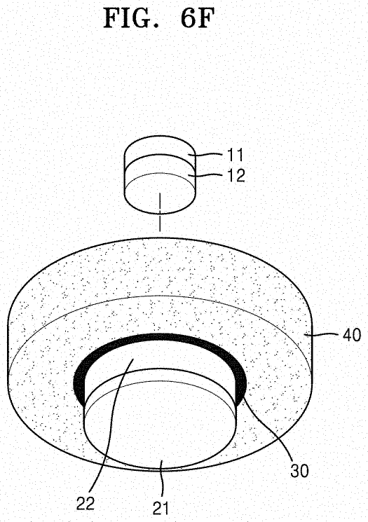

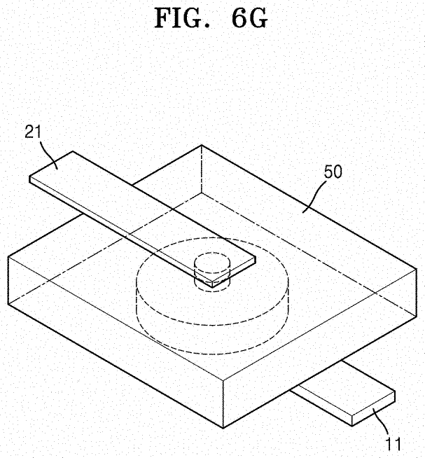

FIGS. 6A to 6G are schematic views that illustrate steps in a method of preparing the secondary battery.

In an embodiment, referring to FIG. 6A, the solid electrolyte layer 40 may be formed by using a LLZO-based ceramic (LiₓLa_{y}Zr_{z}O₁₂, where 1<x<5, 0<y<4, and 0<z<4). In an embodiment, starting raw materials (e.g., lithium nitrate, lanthanum nitrate, and zirconium oxychloride) are mixed in predetermined amounts to prepare a mixture. The mixture is prepared as a pellet and reacted at a predetermined reaction temperature in vacuum, and the resultant is cooled to prepare a LLZO-based solid electrolyte material. In an embodiment, when a mechanical milling method is used, starting raw materials (e.g., lithium nitrate, lanthanum nitrate, and zirconium oxychloride) are reacted by stirring using a ball mill, and thus a LLZO-based solid electrolyte material may be prepared. Although a stirring rate and a stirring time of the mechanical milling method are not particularly limited, a production rate of the LLZO-based solid electrolyte material may increase as the stirring rate increases, and a conversion rate from the raw materials to the LLZO-based solid electrolyte material may increase as the stirring time increases.

In an embodiment, when the mechanical milling method is used, the starting raw materials may be stirred in isopropyl alcohol at a stirring rate of 200 rpm and a stirring time of 10 hours. After completing the stirring process, the resultant may be dried and undergo a calcine process for 2 hours to 4 hours at a temperature of about 1000° C. A pressure of 50 MPa is applied to the calcined LLZO-based powder to prepare the powder in the form of a pellet, and the pellet is sintered for about 1 hour to about 24 hours at a temperature of about 1200° C. and then cooled to prepare a LLZO-based solid electrolyte material.

Subsequently, the mixed raw materials obtained by the melt-cooling method or mechanical milling method is heat-treated at a predetermined temperature and pulverized to prepare a solid electrolyte in the form of a particle. When the solid electrolyte has glass transition characteristics, the structure of the solid electrolyte may change from amorphous to crystalline by the heat-treatment.

Next, the solid electrolyte thus obtained may be deposited by using, for example, a suitable layer-forming method such as an aerosol deposition method, a cold spray method (at 20° C.), or a sputtering method to prepare the solid electrolyte layer 40. The solid electrolyte layer 40 may be prepared by applying a pressure to a plurality of solid electrolyte particles. A solid electrolyte, a solvent, and a binder are mixed and coated on a substrate and dried and pressed to prepare the solid electrolyte layer 40.

Then, referring to FIG. 6B, two surfaces of the solid electrolyte layer 40 are mechanically polished to produce clean and flat surfaces. In an embodiment, the two surfaces of the solid electrolyte layer 40 may be mechanically polished by using sandpaper including silicon carbide (SiC) for about 30 seconds to about 2 minutes.

Next, referring to FIG. 6C, the solid electrolyte layer 40 may be acid treated and then dried. In an embodiment, the solid electrolyte layer 40 may be acid treated for about 5 minutes in a phosphoric acid solution (H₃PO₄). In an embodiment, the solid electrolyte layer may be oxidized using an oxidizing gas, and the oxidizing gas may be, for example, oxygen or air, but is not limited thereto. Thereafter, the solid electrolyte layer 40 is coated with ethanol and air-dried.

Subsequently, in an embodiment, referring to FIG. 6D, the graphite interlayer 30 is coated on one surface of the solid electrolyte layer 40. In an embodiment, the graphite material in the graphite interlayer 30 may have a crystallite size (La) of the graphite material of about 1095 Å and a hexagonal interplanar spacing (Lc) in a c-axis direction of about 607 Å. For example, in an embodiment, the graphite interlayer 30 may be obtained from a graphite material (HB model available from Steadler). In an embodiment, the graphite interlayer 30 may be coated on a surface of the solid electrolyte layer 40 by using a drawing method or may be disposed on one surface of the solid electrolyte layer 40 by using an ink-coating method.

Next, referring to FIG. 6E, a stack including the anode current collector 21 and the metal layer 22 attached to each other is attached on the graphite interlayer 30. In an embodiment, the metal layer 22 in the form of a metal foil is attached to the anode current collector 21 in the form of thin film including copper. Here, the metal layer 22 may be a lithium foil or a lithium alloy foil. The stack including the anode current collector 21 and the metal layer 22 attached to each other is attached on the graphite interlayer 30. In an embodiment, the stack including the anode current collector 21 and the metal layer 22 attached to each other may be attached on the graphite interlayer 30 by using a cold isostatic press process. Here, the press process may be performed at a pressure of 250 MPa for 3 minutes at 20° C.

Then, referring to FIG. 6F, the cathode layer 10 is attached on the other surface of the solid electrolyte layer 40. In an embodiment, materials (a cathode active material, NCM-111, and a binder) forming the cathode active material 12 is impregnated with an ion-based electrolyte solution to prepare an active material. Subsequently, the thus obtained active material is coated and dried on the cathode current collector 11. Next, the resulting stack is pressed (e.g., pressing by using cold isostatic pressing) to prepare the cathode layer 10. The pressing process may be omitted. A mixture of materials constituting the cathode active material layer 12 is compressed into the form of a pellet or stretched (molded) in the form of sheet to prepare the cathode layer 10. When the cathode layer 10 is prepared in this manner, the cathode current collector 11 may be omitted. Thus prepared cathode layer 10 may be attached to the other surface of the solid electrolyte layer 40 by using a pressing process.

Next, referring to FIG. 6G, the anode layer 20, the graphite interlayer 30, the solid electrolyte layer 40, and the cathode layer 10 are sealed by a laminating film 50 in vacuum, thereby completing manufacture of the secondary battery according to an embodiment. Each part of the cathode current collector 11 and the anode current collector 21 may be projected out of the laminate film 50 in a manner that does not break vacuum of the battery. The projected parts may be a cathode layer terminal and an anode layer terminal.

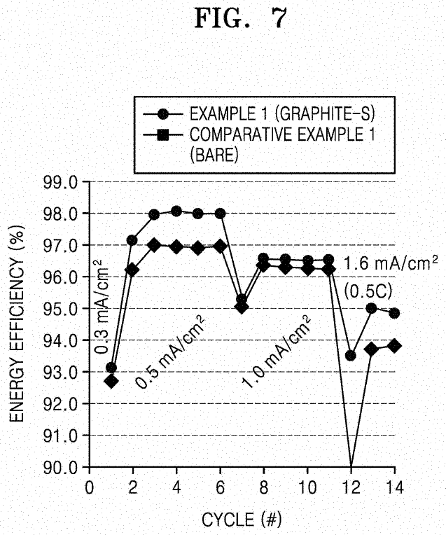

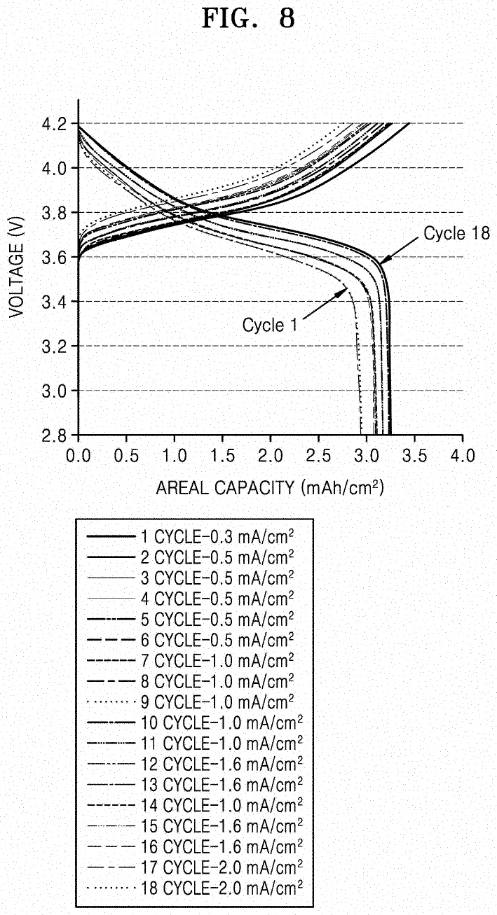

FIG. 7 is a graph that shows output characteristics of the secondary battery according to an embodiment and a secondary battery prepared in Comparative Example 1. FIG. 8 is a graph that shows charge/discharge characteristics of the secondary battery according to an embodiment. As shown in FIG. 8, an areal capacity at cycle 1, and at cycle 18, demonstrate that the areal capacity at cycle 1 and cycle 18 is maintained within a narrow range irrespective of the current applied to the battery

The secondary battery 1 according to an embodiment is charged over a charge capacity of the graphite interlayer 30. That is, the graphite interlayer 30 is overcharged. During initial charge, lithium is intercalated into the graphite interlayer 30. When charging is done over a capacity of the graphite interlayer 30, lithium is precipitated in the metal layer 22 (or on the metal layer 22). During discharge, lithium of the graphite interlayer 30 and lithium in the metal layer 22 (or on the metal layer 22) is ionized and moves toward the cathode layer 10. Therefore, the secondary battery 1 may use lithium as an anode active material. Also, when the graphite interlayer 30 covers the metal layer 22, the graphite interlayer 30 serves as a protection layer of the metal layer 22 and may suppress precipitation-growth of dendrites at the same time. Therefore, short-circuits and capacity decrease of the secondary battery 1 may be suppressed, and, further, characteristics of the secondary battery 1 may improve.

### EXAMPLES

### Example 1

In Example 1, a secondary battery was prepared by undergoing processes as referred to in FIGS. 6A to 6G.

### Comparative Example 1

In Comparative Example 1, a graphite interlayer 30 is a graphite material which includes bare graphite particles. A size (La) of crystals of the bare graphite particles and a hexagonal interplanar spacing (Lc) in a c-axis direction may not be measured. A secondary battery was prepared in the same manner as in Example 1 to perform a test, except that the graphite interlayer 30 including the graphite material was used.

### Charge/Discharge Analysis

Charge/discharge characteristics of the secondary batteries prepared in Example 1 and Comparative Example 1 were evaluated by the following charge/discharge test. The charge/discharge test was performed by placing the secondary batteries in a constant-temperature chamber at a temperature of 60° C. In the 1st cycle to the 6th cycle, each of the secondary batteries were charged with a constant current of 0.5 mA/cm² until a battery voltage was 4.2 V and charged with a constant voltage of 4.2 V. Then, the battery was discharged with a constant current of 0.5 mA/cm² until a battery voltage was 2.8 V. In the 7th cycle to the 11th cycle, the battery was charged with a constant current of 1.0 mA/cm² until a battery voltage was 4.2 V and charged with a constant voltage of 4.2 V. Then, the battery was discharged with a constant current of 1.0 mA/cm² until a battery voltage was 2.8 V. In the 12th cycle to the 16th cycle, the battery was charged with a constant current of 1.6 mA/cm² until a battery voltage was 4.2 V and charged with a constant voltage of 4.2 V. Then, the battery was discharged with a constant current of 1.6 mA/cm² until a battery voltage was 2.8 V. In the 17th cycle to the 18th cycle, the battery was charged with a constant current of 2.0 mA/cm² until a battery voltage was 4.2 V and charged with a constant voltage of 4.2 V.

Referring to FIGS. 7 and 8, the battery of Example 1 was stably charged/discharged until at least 18th cycle, and it was confirmed that energy efficiency of the battery of Example 1 was better than that of the battery of Comparative Example 1.

According to an embodiment, a secondary battery may prevent a short-circuit caused by lithium (lithium metal) precipitated at a side of an anode during a charge process.

The secondary battery according to an embodiment may have excellent charge/discharge characteristics.

The secondary battery according to an embodiment may have advantageous characteristics such as ease of process and reduced manufacturing costs.

While many details are set forth in the description above, they should be construed as illustrative of preferred embodiments, rather than to limit the scope of the invention. For example, it may be known to one of ordinary skill in the art that various modifications may be made on a secondary battery and a method of preparing the secondary battery described in reference to the drawings. In particular, for example, the secondary battery may be an all-solid secondary battery or may partially use a liquid electrolyte, and the concept and principle of embodiments may be applied to batteries in addition to a lithium battery. For this reason, the scope of the invention should not be defined by the described embodiments, but by the technical spirit described in the claims.

It should be understood that embodiments described herein should be considered in a descriptive sense only and not for purposes of limitation. Descriptions of features, aspects, or advantages within each embodiment should be considered as available for other similar features, aspects, or advantages in other embodiments. While one or more embodiments have been described with reference to the figures, it will be understood by those of ordinary skill in the art that various changes in form and details may be made therein without departing from the spirit and scope as defined by the following claims.

What is claimed is:

1. A secondary battery comprising:
a cathode layer comprising a cathode active material layer;
an anode layer comprising an anode current collector and a metal layer disposed on the anode current collector;
a solid electrolyte layer disposed between the cathode layer and the anode layer; and
a graphite interlayer disposed between the solid electrolyte layer and the anode layer,
wherein the graphite interlayer comprises a graphite material and
a crystallite of the graphite material has a crystallite size of about 1000 angstroms to about 1500 angstroms measured from a (110) diffraction peak, when analyzed by X-ray diffraction,
and has a hexagonal interplanar spacing about 500 angstroms to about 800 angstroms in a c-axis direction measured from a (002) diffraction peak, when analyzed by X-ray diffraction, and has an aspect ratio is in a range of about 0.44 to about 0.55.

2. The secondary battery of claim 1, wherein
the metal layer comprises at least one of lithium or a lithium alloy.

3. The secondary battery of claim 1, wherein
the graphite interlayer further comprises at least one of iron, zirconium, gold, platinum, palladium, silicon, silver, aluminum, bismuth, tin, or zinc.

4. The secondary battery of claim 1, wherein
the cathode active material layer comprises at least one of a lithium cobalt oxide, a lithium nickel oxide, a lithium nickel cobalt oxide, a lithium nickel cobalt aluminum oxide, a lithium nickel cobalt manganese oxide, a lithium manganate, or a lithium iron phosphate.

5. The secondary battery of claim 1, wherein the cathode active material layer comprises at least one of LiNiₓCo_{y}Al_{z}O₂ or LiNiₓCo_{y}Mn_{z}O₂, wherein 0<x<1, 0<y<1, 0<z<1, and x+y+z=1.

6. The secondary battery of claim 1, wherein
the solid electrolyte layer comprises at least one of Li₃₊ₓLa₃M₂O₁₂, wherein 0≤x≤10, Li₃PO₄, LiₓTi_{y}(PO₄)₃, wherein 0<x<2 and 0<y<3, LiₓAl_{y}Ti_{z}(PO₄)₃, wherein 0<x<2, 0<y<1, and 0<z<3, Li_{1+x+y}(AlₐGa₁₋ₐ)ₓ(Ti_{b}Ge_{1-b})₂₋ₓSi_{y}P_{3-y}O₁₂, wherein 0≤x≤1, 0≤y≤1, 0≤a≤1, and 0≤b≤1, LiₓLa_{y}TiO₃, wherein 0<x<2 and 0<y<3, a LiₓM_{y}P_{z}S_{w}, wherein M is at least one of Ge, Si, or Sn, and 0<x<4, 0<y<1, 0<z<1, and 0<w<5, LiₓN_{y}, wherein 0<x<4 and 0<y<2, LiₓPO_{y}N_{z}, wherein 0<x<4, 0<y<5, and 0<z<4, a LiₓSi_{y}S_{z}, wherein 0<x<3, 0<y<2, and 0<z<4, a LiₓP_{y}S_{z}, wherein 0<x<3, 0<y<3, and 0<z<7, Li₂O, LiF, LiOH, Li₂CO₃, LiAlO₂, a Li₂O—Al₂O₃—SiO₂—P₂O₅—TiO₂—GeO₂, or a LiₓLa_{y}M_{z}O₁₂, wherein M is at least one of Te, Nb, or Zr, and 1<x<5, 0<y<4, and 0<z<4.

7. The secondary battery of claim 1, wherein
a thickness of the solid electrolyte layer is in a range of about 10 micrometers to about 250 micrometers.

8. The secondary battery of claim 1, wherein the graphite interlayer further comprises a binder.

9. The secondary battery of claim 9, wherein the binder comprises at least one of polyvinylidene fluoride, polyvinyl alcohol, or a polyvinyl alcohol-polyacrylic acid copolymer, carboxymethyl cellulose, styrene-butadiene rubber and an amount of the binder is in a range of about 1 weight percent to about 10 weight percent, based on the total weight of the graphite interlayer.

10. The secondary battery of claim 1, wherein
the lithium alloy comprises at least one of a Li—Al alloy, a Li—Sn alloy, a Li—In alloy, a Li—Ag alloy, a Li—Au alloy, a Li—Zn alloy, a Li—Ge alloy, or a Li—Si alloy.

11. The secondary battery of claim 1, wherein the secondary battery is a lithium battery.

12. The secondary battery of claim 1, wherein
the cathode layer further comprises a cathode current collector disposed on a surface of the cathode active material layer.

13. The secondary battery of claim 1, wherein
a thickness of the graphite interlayer is in a range of about 0.1 micrometer to about 0.3 micrometer.

14. A method of preparing a secondary battery, the method comprising:
providing a solid electrolyte layer;
mechanically milling a surface of the solid electrolyte layer to provide a milled surface;
contacting the solid electrolyte layer with an oxidizing gas to provide an oxidized solid electrolyte layer;
drying the oxidized solid electrolyte layer in air to provide a dried solid electrolyte layer;
coating a graphite interlayer on the milled surface of the solid electrolyte layer to provide a coated solid electrolyte layer;
disposing a stack comprising a metal layer and an anode current collector on the coated solid electrolyte layer to form an anode layer; and
disposing a cathode layer comprising a cathode active material layer on a surface of the dried solid electrolyte layer opposite to the anode layer to form a secondary battery,
wherein the graphite interlayer comprises a graphite material and
a crystallite of the graphite material has a crystallite size of about 1000 angstroms to about 1500 angstroms measured from a (110) diffraction peak, when analyzed by X-ray diffraction,
and has a hexagonal interplanar spacing about 500 angstroms to about 800 angstroms in a c-axis direction measured from a (002) diffraction peak when analyzed by X-ray diffraction,
and has an aspect ratio in a range of about 0.44 to about 0.55.

15. The method of claim 14, wherein
the coating of the graphite interlayer is provided by ink coating or pencil drawing.

16. The method of claim 14, wherein
the disposing of the stack comprising a metal layer and an anode current collector on the coated solid electrolyte layer further comprises cold isostatic pressing to dispose the stack comprising a metal layer and an anode current collector on the coated solid electrolyte layer.

17. The method of claim 14, wherein
the cathode active material layer comprises at least one of a lithium cobalt oxide, a lithium nickel oxide, a lithium nickel cobalt oxide, a lithium nickel cobalt aluminum oxide, a lithium nickel cobalt manganese oxide, a lithium manganate, or a lithium iron phosphate.

18. The method of claim 14, wherein
the solid electrolyte layer comprises at least one of Li₃₊ₓLa₃M₂O₁₂, wherein 0≤x≤10, Li₃PO₄, LiₓTi_{y}(PO₄)₃, wherein 0<x<2 and 0<y<3, LiₓAl_{y}Ti_{z}(PO₄)₃, wherein 0<x<2, 0<y<1, and 0<z<3, Li_{1+x+y}(AlₐGa₁₋ₐ)ₓ(Ti_{b}Ge_{1-b})₂₋ₓSi_{y}P_{3-y}O₁₂, wherein 0≤x≤1, 0≤y≤1, 0≤a≤1, and 0≤b≤1, LiₓLa_{y}TiO₃, wherein 0<x<2 and 0<y<3, a LiₓM_{y}P_{z}S_{w}, wherein M is at least one of Ge, Si, or Sn, and 0<x<4, 0<y<1, 0<z<1, and 0<w<5, LiₓN_{y}, wherein 0<x<4 and 0<y<2, LiₓPO_{y}N_{z}, wherein 0<x<4, 0<y<5, and 0<z<4, a LiₓSi_{y}S_{z}, wherein 0<x<3, 0<y<2, and 0<z<4, a LiₓP_{y}S_{z}, wherein 0<x<3, 0<y<3, and 0<z<7, Li₂O, LiF, LiOH, Li₂CO₃, LiAlO₂, a Li₂O—Al₂O₃—SiO₂—P₂O₅—TiO₂—GeO₂, or a LiₓLa_{y}M_{z}O₁₂, wherein M is at least one of Te, Nb, or Zr, and 1<x<5, 0<y<4, and 0<z<4.

19. The method of claim 14, wherein
the metal layer comprises at least one of lithium or a lithium alloy.

20. The method of claim 14, wherein
the cathode layer further comprises a cathode current collector disposed on a surface of the cathode active material layer.

21. The method of claim 14, wherein
the graphite interlayer further comprises at least one of iron, zirconium, gold, platinum, palladium, silicon, silver, aluminum, bismuth, tin, or zinc.

22. The method of claim 14, wherein
a thickness of the graphite interlayer is in a range of about 0.1 micrometer to about 0.3 micrometer.
